(19) United States
(12) Patent Application Publication
(10) Pub. No.: US 2005/0115041 A1
(43) Pub. Date: Jun. 2, 2005

(54) Fastener starting tool

(76) Inventors: Michael J. Tilley, Phoenix, AZ (US); Douglas Linc Clark, Phoenix, AZ (US)

Correspondence Address: ETHERTON LAW GROUP, LLC, 5555 E. VAN BUREN STREET, SUITE 100, PHOENIX, AZ, 85008, US

(21) Appl. No.: 10/726,801

(22) Filed: Dec. 2, 2003

(51) Int. Cl. B25B 27/14

(52) U.S. Cl. 29/275

(57) ABSTRACT

A hollow-end fastener starting tool and method to more efficiently seat a fastener in a desired location or aperture. The inside diameter of the hollow-end is slightly larger than the outside diameter of the fastener. To securely hold the fastener in the tool, a small dab of a tacky substance is put on the end of the fastener and the tacky end is inserted into the hollow end of the tool. The tacky substance holds the fastener in place inside the tool. The fastener is then inserted into the aperture or at some other desired location. Once started, the friction holding the fastener in place is greater than the friction holding the tacky end in the tool. The starting tool can be pulled away from the fastener, leaving the fastener in place for seating.

### FIELD OF INVENTION

This invention relates generally to an apparatus and method for starting and installing fasteners. This invention relates particularly to an apparatus that provides a means to securely hold a fastener until the fastener is securely started in the desired aperture or location. More particularly, this invention provides a means to securely start a roll pin fastener into an aperture without the pin dropping prior to it being fully seated.

### BACKGROUND

Fastener installation can be a tedious and frustrating task. This is especially true if the fastener is small and the desired location of the aperture for the fastener is in a confined space or is difficult to reach. The installation of roll pin fasteners in the automotive industry and firearm assembly are examples of this tedious task.

A roll pin is fastener that comprises a hollow tube of metal cut longitudinally along the length of the tube, thereby forming a “C”-shaped cross section. The roll pin is driven into a hole of slightly smaller diameter, causing the edges of the cut to compress against each other, so that the resulting cross-section is a complete circle. Roll pins come in various sizes, typically less than 1 inch in diameter.

Roll pins are used to assemble firearms, industrial, automotive, or other heavy equipment, and other solid articles. The pins are often used in cramped spaces that are difficult to reach. To seat a roll pin with traditional tools, the user balances the pin on the convex end of a roll pin punch and delicately slides one end of the roll pin into the hole. The end of the punch is then tapped with a hammer until the pin is driven far enough into the hole to remain in place until it can be fully driven into the hole with another tool. Alternatively, the user uses needle-nose pliers to grasp the pin and insert it into the hole, and the pin is hammered directly until fully seated.

Because the roll pins are so tiny and the placement so difficult, pins are often dropped before they can be seated in place, causing repeated trial-and-effort to get the pin seated. This is very frustrating to the user, and time-consuming too.

The prior art is replete with inventions designed to solve the problem of holding a fastener securely for easy placement. Many of these devices utilize variations of pincher arms to hold the fastener. See, for example, Suga, U.S. Pat. No. 4,363,250; Duffee U.S. Pat. No. 4,856,697; and O. Haas, U.S. Pat. No. 2,360,054. Other inventions use various compressive means to hold the fasteners in place. For example, in U.S. Pat. No. 3,788,537, Fox discloses the use of an o-ring or u-shaped spring to hold the fastener in the tool and in U.S. Pat. No. 4,709,841, Wollar lines a hollow bore with compressible rubber. Others have developed magnetic tools, such as Hitoshi, Japanese Publication No. 07164346; A, Stillwagon, U.S. Pat. No. 3,392,767; and Eggert et al. U.S. Pat. No. 5,603,248. However, these devices have complicated structures for holding the fasteners, and none provide a simple solution that is easy to use and relatively inexpensive to manufacture. Consequently, none of these devices have met with significant commercial success.

The placement and installation of other fasteners, such as shear pins, upholstery nails, or weatherstrip nails, for example, can be just as tedious and frustrating. Therefore, there is a need to provide an improved tool and method to aid the installation of fasteners.

Therefore, it is an object of this invention to provide an apparatus that eliminates the dropping of fasteners prior to placement. It is another object of this invention to minimize repeated attempts to start fasteners, providing more efficient and effortless placement of fasteners. It is a further object to provide a tool for holding fasteners that is simple to make and use.

### SUMMARY OF THE INVENTION

The present invention is a tool that makes fastener placement effortless by providing a secure way to hold the fastener until it is started in the desired aperture or location. More specifically, the present invention makes roll pin fastener placement and installation more efficient by providing a secure way to hold and start the roll pin in the desired aperture.

The device is a hollow-end fastener starting tool. The inside diameter of the hollow-end is slightly larger than the outside diameter of the fastener. To insert a fastener, a small dab of a tacky substance is applied to the end of the fastener, and the tacky end is inserted into the hollow end of the tool. The tacky substance holds the fastener in place inside the tool. In the preferred embodiment, the fastener is a roll pin. Wheel bearing grease is applied to one end of the roll pin and the tacky end is then inserted into the hollow end of the tool. The roll pin is then inserted into a desired hole, and the user hammers the end of the starting tool, starting the roll pin into the hole. Once started, the friction holding the fastener in place is greater than the friction holding the tacky end in the tool, so the starting tool can just be pulled away from the fastener, leaving the fastener in place to be fully seated.

### BRIEF DESCRIPTION OF THE DRAWINGS

FIG. 1 is a perspective view of an embodiment of the present invention.

FIG. 2 is a perspective view of the roll pin fastener.

FIG. 3 is an enlarged, cut-away perspective view of the distal end portion of the embodiment of FIG. 1.

FIG. 4 is a cross-sectional view of the embodiment of FIG. 1 along the lengthwise axis.

FIG. 5 is a side elevational view of the tool of FIG. 1.

FIG. 6 is a cross-sectional view of the distal end of the tool of FIG. 1.

FIG. 7 is an illustration of the application of the present invention, in partial cross-section.

FIG. 8 is a perspective view of an alternate embodiment of the present invention.

### DETAILED DESCRIPTION OF THE INVENTION

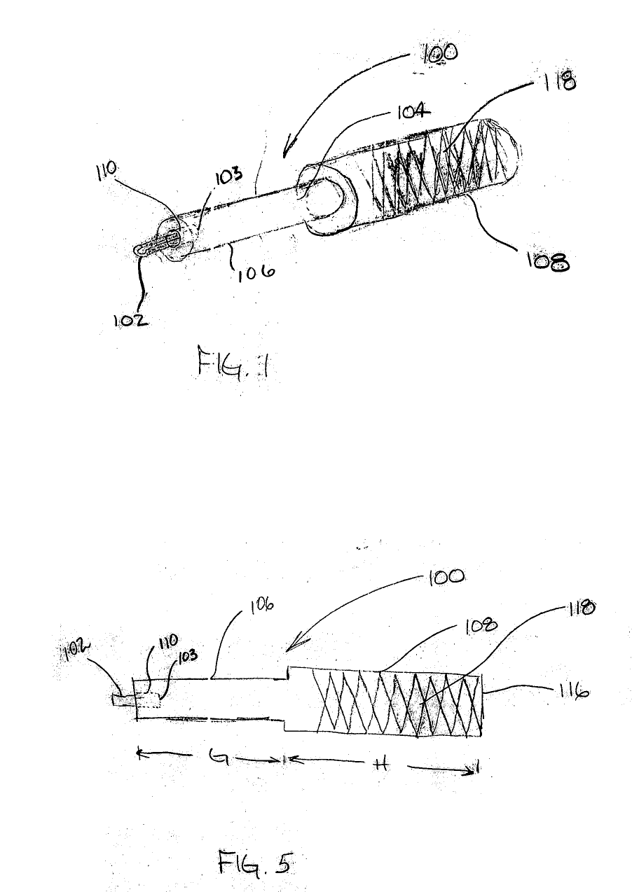

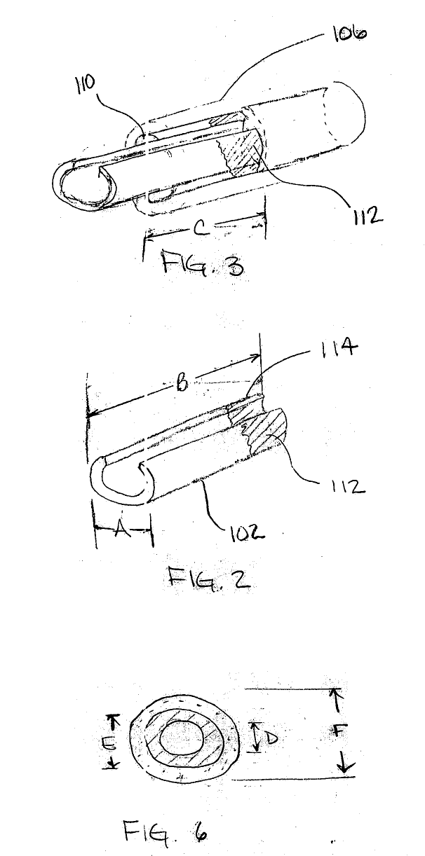

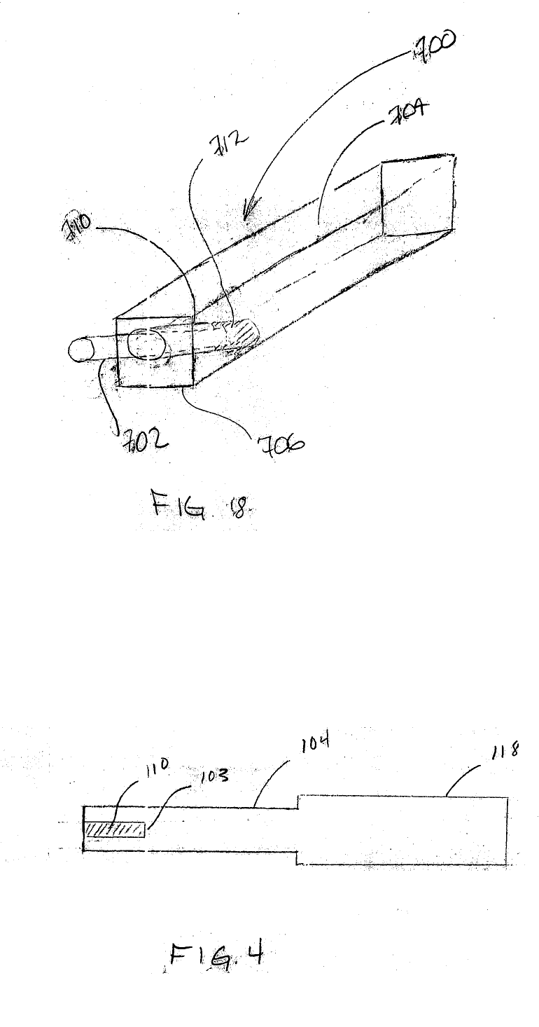

This invention is an apparatus and method for more efficiently starting fasteners in apertures or desired locations. Referring to FIGS. 1 through 7, there is illustrated the preferred embodiment of the present invention generally designated as starting tool 100 which is used to seat roll pin 102 in a desired aperture 124. As shown in FIG. 1, roll pin 102 is placed in the bore 110 of starting tool 100 and then started in the desired location by the user 150. Prior to placing roll pin 102 into bore 110, the user 150 applies an amount of a tacky substance 112 on an end of roll pin 102, as shown in FIG. 2. The user 150 then places the tacky end of the fastener 114 into the bore 110 of starting tool 100, as shown in FIG. 3. Alternatively, the tacky substance 112 could be placed in the bore instead of on the fastener itself. The use of the tacky substance 112 in combination with the size and shape of bore 110 allows the user 150 to more efficiently retain the fastener in the bore prior to seating the roll pin 102 into the desired location or aperture 124.

In the preferred embodiment of the invention starting tool 100 is a shaft 104, having a distal end portion 106 and a proximal end portion 108. As shown in FIGS. 1 and 3, bore 110 is located in the distal end portion of the shaft 106. The bore 110, in the preferred embodiment, is axial along the distal end portion of the shaft 106 and is shaped and sized to accommodate a roll pin 102, as shown. The size and placement of the bore 110 may vary, depending on the type of fastener being started. For example, the bore may be quite shallow for optimizing use with fasteners with heads, such as upholstery nails or brads. Longer and heavier fasteners may require a deeper bore. The width of the bore may also vary depending on the type and width of fastener being seated.

The proximal end portion of the shaft 108 is used to aid the user 150 in holding or gripping the starting tool 100 during use, thus, in this embodiment, the proximal end portion of the shaft 108 is larger in diameter than the distal end portion of the shaft 106. More specifically, as shown in FIGS. 5 and 6 of the preferred embodiment of this invention for placing a roll pin of about 3/16 inch diameter in an automotive transmission, the dimensions of the distal end portion of the shaft 106 and proximal end portion of the shaft 108 are: distal end portion of the shaft diameter E is about 13/32 inches; distal end portion of the shaft length G is about 2 and 7/16 inches; proximal end portion of the shaft diameter F is about 5/8 inches; proximal end portion of the shaft length H is about 3 and 1/8 inches. To better enable the user's 150 hold or grip on the starting tool 100, cross-cut knurls 118, as shown in FIG. 1, are machined onto the proximal end portion of the shaft 108.

In the preferred embodiment of the invention, the shaft 104, is made of metal and is substantially cylindrical in shape. Under appropriate circumstances, such as use of varied fastener types or applications, the shaft 104 may be made from a material other than metal, such as wood, plastic, or some other application appropriate material. Additionally, the size and shape of the distal end portion of the shaft 106 and the proximal end portion of the shaft 108 may vary depending on fastener type or application. For example, under appropriate circumstances, it may be desirable to have a bend in the distal portion of the shaft 106 to aid in placement of the fastener, or the bore may be made at an angle to the axis of the shaft, as illustrated in FIG. 8.

As previously discussed, the shape and size of bore 110 is specific to the type of fastener in use. The roll pin 102 used in the preferred embodiment of this invention is a roll pin fastener. As shown in FIG. 2, the roll pin 102 has a fastener length A of about 13/16 inches and a fastener outside diameter B of about 3/16 inches. The bore 110 of the preferred embodiment of this invention, as shown in FIGS. 3 and 6, for use with the described roll pin 102, is substantially circular with a bore length C of about 1/4 inches bore diameter D of about 7/32 inches. The dimensions of the bore 110 combined with the use of the tacky substance 112 on the tacky end of the fastener 114 provide a sufficient amount of friction to hold the fastener in starting tool 100 for starting of the fastener into the desired location or aperture 124.

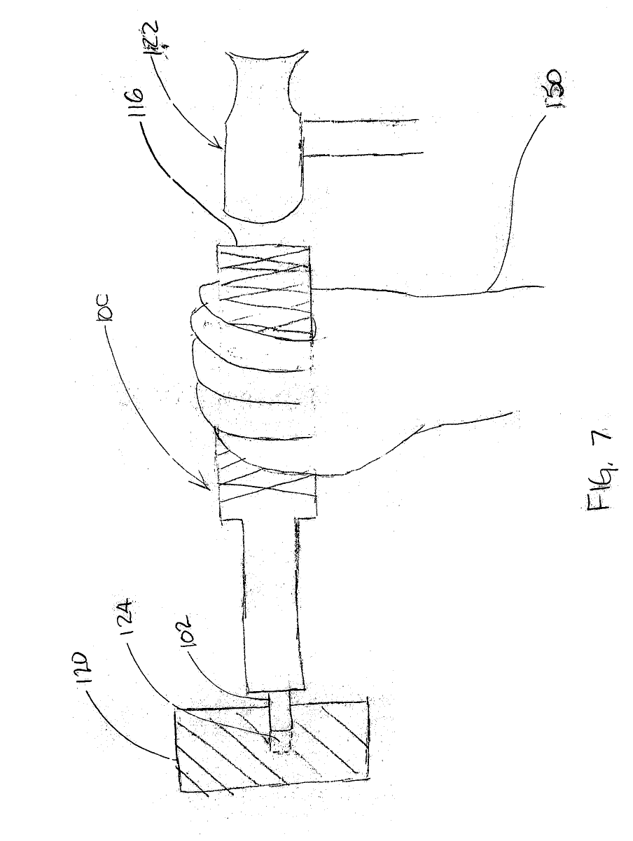

The end 116 of the proximal end portion of the shaft 108 of the preferred embodiment of this invention, as shown in FIGS. 5 and 7, is substantially flat. As shown in FIG. 7, this allows the user 150 to fully tap the end 116 with a hammer 122 or other blunt object, as necessary, forcing the roll pin 102 into the desired aperture 124 or object 120. Because the roll pin nature is to be crushed into a smaller diameter when forced into an aperture, the end of the bore 103 that is inside the shaft 104 should also be substantially flat. This will prevent the fastener from becoming stuck inside the shaft when the tool is tapped. Once the roll pin 102 is started in the desired aperture 124, the resulting compression and force (friction) on the roll pin 102 by the aperture 124 is greater than that provided by the tacky substance 112 and bore 110, thus permitting the user 150 to remove the starting tool 100 from the proximity of the roll pin 102, while having the roll pin retained in the aperture 124, and allowing completion of the seating of the roll pin. The tacky substance 112 used in the preferred embodiment of this invention is wheel bearing grease. However, under appropriate circumstances, the tacky substance 112 may be some other substance of varying viscosity, for example petroleum jelly, oil, adhesive, or the like, depending on the application. The more tacky a substance is, the more the substance tends to resist releasing the fastener or the heavier a fastener it can retain. Therefore, a more tacky substance may be required when using a larger fastener and a less tacky substance when using a smaller fastener.

An alternative embodiment of the invention is shown in FIG. 8. The fastener starting tool 700, as shown, is for starting a shear pin fastener 702. As shown, the starting tool shaft 704 is rectangular in shape with the bore 710 non-axial along the shaft 704 from the distal end of the shaft 706. Under appropriate circumstances, the shape of the shaft 704 and bore 710 may vary, for example, it may be desirable to have a hexagonal shape shaft 704 for holding purposes or a hexagonal shape bore 710 because of the shape of the fastener. Additionally, the placement of the bore 710 within the shaft 704 may vary; it may be axial or non-axial depending on the application or type of fastener in use.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A tool for starting a fastener, the tool comprising:
a) a shaft having a bore; and
b) a tacky substance in the bore to hold the fastener in the bore until the fastener is started in a desired location.

2. The tool according to claim 1 wherein the shaft further comprises a distal end and a proximal end, and the bore extends from the distal end into the shaft

3. The tool according to claim 2 wherein the end of bore in the shaft is substantially flat.

4. The tool according to claim 2 wherein the shaft is comprised of metal.

5. The tool according to claim 2 wherein the shaft is substantially cylindrical.

6. The tool according to claim 2 wherein the fastener is a roll pin.

7. The tool according to claim 2 wherein the bore axial bore and of substantially circular cross-section.

8. The tool according to claim 2 wherein the proximal end of the shaft is substantially flat.

9. The tool according to claim 2 wherein the tacky substance is an adhesive.

10. The tool according to claim 2 wherein the tacky substance is grease.

11. The tool according to claim 10 wherein the grease is wheel bearing grease.

12. The tool according to claim 2 wherein the shaft is comprised of a first portion that extends from the distal end to a second portion that extends from the end of the first portion to the proximal end of the shaft.

13. The tool according to claim 12 wherein the first portion has a smaller diameter than the second portion of the shaft.

14. A roll pin punch tool for starting a roll pin, the tool comprising:
a) a metal shaft having a distal end and a proximal end, the shaft divided into a first portion that extends from the distal end to a second portion that extends from the end of the first portion to the proximal end of the shaft, the first portion having a smaller diameter than the second portion;
b) an axial bore of substantially circular cross-section that is slightly larger than the diameter of the roll pin, the bore extending from the distal end into the first portion and terminating in a flat end;
c) the second portion having knurls and being substantially flat at the proximal end to receive blows to start the pin in a desired aperture; and
d) wheel bearing grease in the axial bore to hold the roll pin in the bore until the roll pin is started tightly in the desired aperture, at which point the friction of the roll pin in the desired aperture is greater than the friction of the roll pin in the greased bore and the pin remains started after the tool is removed.

15. The tool according to claim 14 wherein the shaft is substantially cylindrical.

16. A method for starting a fastener, the method comprising:
a) using a shaft having a bore;
b) placing an amount of a tacky substance on an end of the fastener;
c) inserting the end of the fastener with the amount of tacky substance into the bore;
d) starting inserted fastener into a desired location; and
e) removing the tool from the fastener.

17. The tool according to claim 2 wherein the end of bore in the shaft is substantially flat.

18. The method according to claim 16 wherein the shaft is comprised of metal.

19. The method according to claim 16 wherein the fastener is a roll pin.

20. The method according to claim 16 wherein the tacky substance is grease.

21. The method according to claim 20 wherein the grease is wheel bearing grease.

22. A method for making a tool to start a fastener, the method comprising:
a) machining a shaft having a distal end and a proximal end, and having a first portion that extends from the distal end of the first portion to a second portion that extends from the end of the first portion to the proximal end of the shaft;
b) machining an axial bore of substantially circular cross-section into the distal end of the shaft, the bore terminating in a flat end in the shaft;
c) machining knurls on the second portion of the shaft; and
d) coating the bore with a tacky substance to receive a fastener.

23. The method of claim 22 wherein the bore is coated with a tacky substance upon insertion into the bore of a fastener coated with tacky substance.

24. The method of claim 22 wherein:
a) the metal shaft is about 5 and 9/16 inches in length;
b) the first portion is about 2 and 7/16 inches in length and extends from the distal end of the first portion to a second portion of about 3 and 1/8 inches in length;
c) the first portion of the shaft has a diameter of about 3/16 inches and the second portion of the shaft has a diameter of about 5/8 inches;
d) the bore has a substantially circular cross-section of about 7/32 inches in diameter and is about 1/4 inches in length; and
e) the tacky substance is grease.
